(19) United States
(12) Patent Application Publication
(10) Pub. No.: US 2017/0185594 A1
(43) Pub. Date: Jun. 29, 2017

(54) UNIVERSAL, HIERARCHICAL LAYOUT OF ASSETS IN A FACILITY

(71) Applicant: Rockwell Automation Technologies, Inc., Mayfield Heights, OH (US)

(72) Inventors: Glenn B. Schulz, Lannon, WI (US); Ardaman Singh Grewal, Milwaukee, WI (US)

(21) Appl. No.: 15/441,784

(22) Filed: Feb. 24, 2017

Related U.S. Application Data
(63) Continuation-in-part of application No. 11/535,672, filed on Sep. 27, 2006.

(51) Int. Cl. G06F 17/30; G05B 19/05; G06F 17/27

(52) U.S. Cl. CPC G06F 17/30011; G06F 17/2705; G05B 19/056; G05B 2219/13004

(57) ABSTRACT

For creating a hierarchical representation, generating functionality for a given asset, and effectuating the functionality, one or more processors to create a hierarchical representation in a data repository of a plurality of assets communicating on at least one network and employed to perform manufacturing within an industrial environment. The one or more processors analyze an electronic document that corresponds to the given asset and generate a functionality of the given asset from the electronic document. The one or more processors determine whether the hierarchical representation is organized according respective functionalities of the plurality of assets or respective physical locations of the plurality of assets in the industrial environment. The one or more processors effectuate the functionality of the given asset in response to a selection of the given asset and the functionality of the given asset.

### CROSS-REFERENCE TO RELATED APPLICATIONS

This is a continuation-in-part application of and claims priority to U.S. patent application Ser. No. 11/535,672 entitled “UNIVERSAL, HIERARCHICAL LAYOUT OF ASSETS IN A FACILITY” and filed on Sep. 27, 2006 for Glenn B. Schulz, which is incorporated herein by reference.

### TECHNICAL FIELD

The claimed subject matter relates generally to asset management in a facility and, more particularly, to representing assets within an industrial facility.

### BACKGROUND

Due to advances in computing technology, businesses today are able to operate more efficiently when compared to substantially similar businesses only a few years ago. For example, internal networking enables employees of a company to communicate instantaneously by email, quickly transfer data files to disparate employees, manipulate data files, share data relevant to a project to reduce duplications in work product, etc. Furthermore, advancements in technology have enabled factory applications to become partially or completely automated. For instance, operations that once required workers to put themselves proximate to heavy machinery and other various hazardous conditions can now be completed at a safe distance therefrom.

Further, imperfections associated with human action have been minimized through employment of highly precise machines. Many of these factory devices supply data related to manufacturing to databases or web services referencing databases that are accessible by system/process/project managers on a factory floor. For instance, sensors and associated software can detect a number of instances that a particular machine has completed an operation given a defined amount of time. Additionally, data from sensors can be delivered to a processing unit related to system alarms. Thus, a factory automation system can review collected data and automatically and/or semi-automatically schedule maintenance of a device, replacement of a device, and other various procedures that relate to automating a process.

Control of a process is typically effectuated through controlling one or more assets within a facility, wherein assets can include hardware, such as programmable logic controllers, machines, switches, and the like as well as software components, such as certain programs, sub-programs, and the like. The assets themselves are typically associated with an asset management program or functionality, which is conventionally is associated with tasks such as backing up devices, checking auditing capabilities, archiving data, periodic scanning of assets to ensure that they are operating without problems, monitoring data entering and leaving a plant floor, and the like. To initiate functionality associated with asset management, one conventionally selects a desired functionality and thereafter assets are displayed that are associated with such functionality. Pursuant to one particular example, to back up a PLC, a user begins such backup by initiating an application function. Thereafter, a schedule is created and functionality associated with backing up the PLC is placed within the schedule. Finally, the schedule is run and the PLC is backed up. There is no convenient mechanism for initially determining what functionality is associated with an asset much less conveniently managing particular assets.

### SUMMARY

A system is disclosed for creating a hierarchical representation, generating functionality for a given asset, and effectuating the functionality. The system includes one or more processors and one or more memory communicatively coupled to the one or more processors. The one or more memory have stored therein computer executable instructions executable by the one or more processors to create a hierarchical representation in a data repository of a plurality of assets communicating on at least one network and employed to perform manufacturing within an industrial environment. The one or more processors further transmit a polling signal on the at least one network and determine an addition of a given asset to the industrial environment based upon at least one response to the polling signal. The given asset is a physical device. The one or more processors analyze an electronic document that corresponds to the given asset. The electronic document is a human language document. The one or more processors generate a functionality of the given asset from the electronic document by parsing a description of a physical operation of the given asset from the electronic document, parsing a functionality label for the physical action from the description of the physical operation, and parsing a control sequence from the electronic document. The functionality is identified by the functionality label and effectuating the functionality activates the control sequence. The one or more processors determine whether the hierarchical representation is organized according respective functionalities of the plurality of assets or respective physical locations of the plurality of assets in the industrial environment and in response to a determination that the hierarchical representation is organized according respective functionalities of the plurality of assets, add the given asset to the hierarchical representation based upon the functionality of the given asset. In response to a determination that the hierarchical representation is organized according respective physical locations of the plurality of assets, the one or more processors add the given asset to the hierarchical representation based upon a physical location of the given asset. The one or more processors effectuate the functionality of the given asset in response to a selection of the given asset and the functionality of the given asset. A method and a computer-readable system also perform the functions of the system

### BRIEF DESCRIPTION OF THE DRAWINGS

FIG. 1 illustrates a system that facilitates managing one or more assets within an industrial environment.

FIG. 2 illustrates a block diagram of an exemplary system that facilitates updating the hierarchical representation of assets with respect to assets that are added, updated, or removed from the industrial environment.

FIG. 3 illustrates a block diagram of an exemplary system that facilitates automatically creating a hierarchical representation of assets.

FIG. 4 illustrates a block diagram of an exemplary system that facilitates updating contents of the hierarchical representation of assets.

FIG. 5 illustrates a block diagram of an exemplary system that facilitates automatically providing asset management in accordance with the claimed subject matter.

FIG. 6 illustrates a block diagram of an exemplary system that facilitates managing one or more assets within an industrial environment.

FIG. 7 illustrates a block diagram of an exemplary system that facilitates providing security mechanisms in connection with managing one or more assets within an industrial environment.

FIG. 8 illustrates an exemplary methodology for managing one or more assets within an industrial environment.

FIG. 9 illustrates an exemplary methodology that facilitates automatically updating the hierarchical representation of assets with respect to assets that are added, updated, or removed from the industrial environment.

FIG. 10 illustrates an exemplary methodology for automatically creating a hierarchical representation of assets.

FIG. 11 illustrates a block diagram of an exemplary data structure that represents a hierarchical structure of an industrial automation system.

FIG. 12 is an exemplary networking environment that can be utilized in connection with the claimed subject matter.

FIG. 13 is an exemplary computing environment that can be utilized in connection with the claimed subject matter.

FIGS. 14A-B illustrates an exemplary methodology for creating a hierarchical representation and effectuating functionality.

FIG. 15 illustrates a schematic block diagram of functionality data for a function of an asset.

FIG. 16 illustrates an exemplary methodology for generating functionality.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that such matter can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component may be, but is not limited to a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, aspects of the claimed subject matter may be implemented as a method, apparatus, or article of manufacture using standard programming and/or engineering techniques to produce software, firmware, hardware, or any combination thereof to control a computer to implement various aspects of the subject invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of what is described herein.

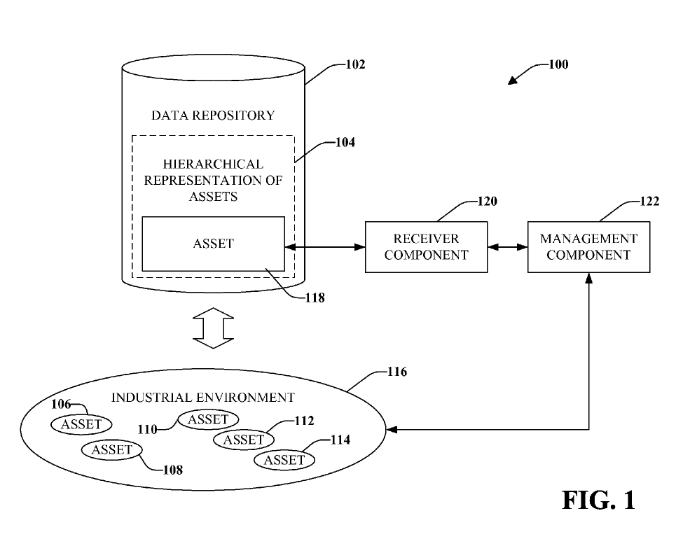

Now referring to the drawings, FIG. 1 illustrates a system 100 that facilitates managing one or more assets within an industrial environment. The system 100 may comprises ROCKWELL® FACTORYTALK® ASSETCENTRE software. The management may relate to validating an asset, backing up an asset, archiving data associated with an asset, updating an asset with new or additional software or firmware, and the like. Further, an asset can be a physical device, such as a programmable logic controller, a pump, a press, and/or a portion thereof. Conventionally, to perform management upon one or more assets within an industrial environment, a desired functionality is selected through an asset management application, a desired asset is located, such asset is checked out and placed within a schedule, the schedule is run, and then the asset is checked back in. Such process is counterintuitive and results in inefficiencies and mistakes in connection with managing multiple assets. The system 100 overcomes such deficiencies by incorporating an asset-centric approach rather than a functionality-centric approach to asset management. The system 100 can include a data repository 102 that can retain a hierarchical representation of assets 104, wherein the hierarchical arrangement can be provided to a user by way of a graphical user interface (not shown). The data repository 102 can be a single data repository and/or can be a distributed data store. The hierarchy can be based upon location of devices (e.g., a region of a factory can have several defined sub-regions, which in tum can comprise sub-regions), standards associated with industry, such as ISA S95, ISA S88, and the like, a proprietary hierarchy that is provided by an enterprise, or any other suitable hierarchy. For instance, a top portion of the hierarchy may be a plant, and a sub-level of the plant may be programmable logic controllers utilized within the plant, and a sub-level of the programmable logic controllers can be devices controlled by such controllers. It is understood that this is but one example of a hierarchy, and is for illustrative purposes only.

The hierarchically representation of assets 104 can represent a hierarchically arrangement of two or more assets 106-114 within an industrial environment 116, such as one that is utilized to manufacture consumables, textiles, automobiles, or any other suitable industrial environment. To illustrate another example hierarchy, the asset 110 may be a programmable logic controller, while the assets 112 and 114 may be different control programs effectuated by the asset 110. Thus, the hierarchical representation of assets 104 may be a combination of physical devices and software.

The hierarchical representation of assets 104 can include a representation of an asset 118 that is requested by a user. For instance, the user may wish to perform particular management functionality with respect to the asset. The user can select the representation of the asset 118 through a receiver component 120, which can be or include a pointing and clicking mechanism, a pressure-sensitive screen, voice commands, software associated with selecting the representation of the asset 118, or any other suitable manner for selecting an asset. Once the representation of the asset 118 has been selected, asset management functionality that is available with respect to the selected asset can be provided to the user. The user can then select such functionality, and a management component 122 can effectuate the requested functionality with respect to the asset within the industrial environment 116. Thus, for instance, if the representation of the asset 118 represents a PLC, and the user selects such representation 118, functionality such as “back up PLC”, “archive data within the PLC”, “update PLC with particular firmware”, and the like can be provided to the user. Once the user selects desired functionality, the management component 122 can automatically perform the requested function. For instance, the PLC can be backed up by the management component 122 if the user selects the “backup PLC” functionality. Accordingly, the system 100 is more intuitive when compared to conventional systems, as effectuation of management functionality is asset-centric. Additionally, locating an asset and functionality associated therewith is made easier through the hierarchical representation of assets.

The management component 122 can additionally cause a selected asset management functionality to permeate through lower levels of the hierarchy. For example, the hierarchy can be based upon location, and various devices and software can reside in the hierarchy beneath the location. If the user selects a certain area and thereafter selects a “validate” functionality, the functionality can be permeated through each of the devices within that area. One skilled in the art will appreciate that various asset management functionalities can be permeated throughout any suitable portions of a hierarchy.

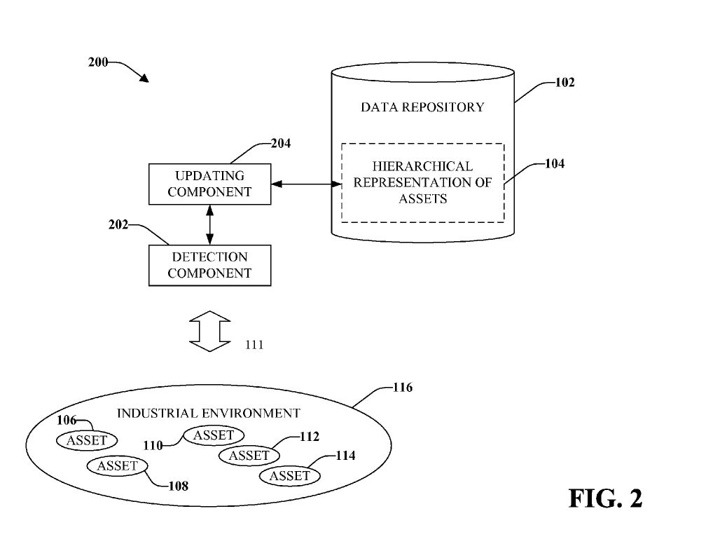

Turning now to FIG. 2, a system 200 that facilitates updating the hierarchical representation of assets 104 with respect to assets that are added, updated, or removed from the industrial environment 116 is illustrated. The system 200 includes a detection component 202 that is communicatively coupled to the assets 106-114 within the industrial environment 116. For instance, the assets 106-114 can be communicatively coupled by way of an intranet or other suitable network. The detection component 202 can determine when an asset has been added to the industrial environment 116, removed from the industrial environment 116, or updated within the industrial environment 116.

Pursuant to one example, the detection component 202 can poll a network 111 to determine whether any alterations have been made with respect to assets resident upon the network 111. In another example, an asset may have sufficient intelligence to initiate a message to the detection component 202, wherein such message can include a type or identity of the asset, location upon a network of the asset, associated assets, etc. Still further, an asset can indicate to the detection component 202 a type of update associated with the asset. Once an alteration occurs with respect to one or more assets within the industrial environment 116 and such alteration has been detected by the detection component 202, an updating component 204 can update the hierarchical representation of assets 104 within the data repository 102. For instance, if an asset is added to the industrial environment 116, the updating component 204 can determine a type of such asset, location of the asset, and the like based upon detections made by the detection component 202. The updating component 204 can then review the structure of the hierarchical representation of assets 104 (e.g., to determine whether it is based on location, functionality of devices, etc.). Once this review has been undertaken, the updating component 204 can intelligently and automatically update the hierarchical representation of assets 104. For instance, if an asset is added to the industrial environment 116, the updating component 204 can add the asset in an appropriate position within the hierarchical representation of assets 104. Additionally, the updating component 204 can associate the asset with a particular graphical icon that is typically associated with assets that are of the same type as the newly added asset.

The updating component 204 can also be employed to associate updated functionality with assets represented within the hierarchical representation of assets.

Pursuant to an example, particular verification functionality may become available with respect to certain PLCs. The updating component can update the functionality with respect to such PLCs that are represented within the hierarchical representation of assets 104. Therefore, if a representation of such asset is selected by a user, the new or enhanced functionality will also be displayed. According to an example, the updating component 204 can be connected to a network (e.g., the Internet) and can receive functionality updates through web services or the like.

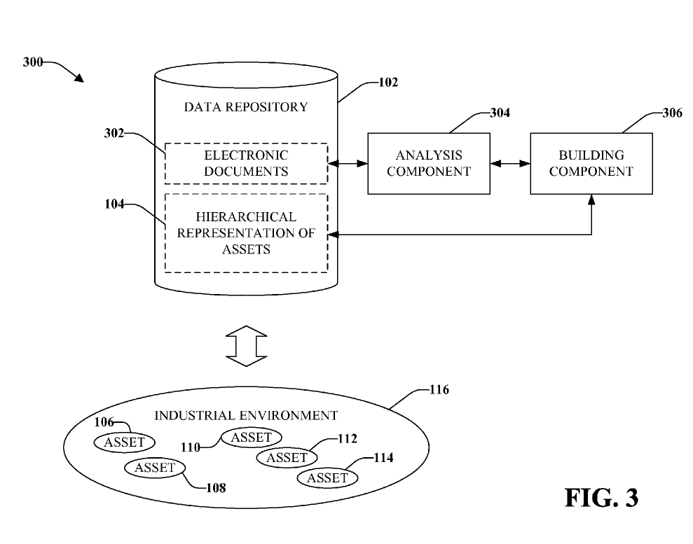

Referring now to FIG. 3, a system 300 for automatically creating the hierarchical representation of assets 104 is illustrated. The system 300 includes the data repository 102 that retains the hierarchical representation of assets 104. The data repository 102 can additionally include electronic documents 302 that are associated with assets that are employed and/or are possibly employed within the industrial environment 116. The electronic documents 302 may be human language electronic documents. In one embodiment, the electronic documents 302 do not include code that is executable by a processor. In addition, the electronic documents 302 may not include source code that is compiled and/or interrupted into code that is executable by a processor.

The electronic documents 302 may be descriptive of an operation of assets. In one embodiment, the electronic documents 302 describe a physical operation of the assets. A physical operation may be comprise a physical motion of an asset such The electronic documents 302 may include operation instructions. The electronic documents 302 may also be warranties or any other suitable documents relating to assets within the industrial environment 116. While shown as residing within the same data repository 102, it is understood and appreciated that the electronic documents 302 and the hierarchical representation of assets can reside upon different storage mediums and/or can be distributed across several storage mediums.

The system 300 further includes an analysis component 304 that analyzes content of the electronic documents to determine type of assets and relationships between assets. Furthermore, the analysis component 304 can analyze metadata associated with the electronic documents 302, such as to determine time of purchase of an asset, identity of an individual who effectuated the purchase, etc. Results of the analysis can be passed to a building component 306, which can then build the hierarchical representation of assets 104. If an individual responsible for creating the hierarchical representation of assets 104 reviews such representation 104 and determines that changes are to be made (after the building component 306 builds such representation 104), the individual can manually undertake the alterations.

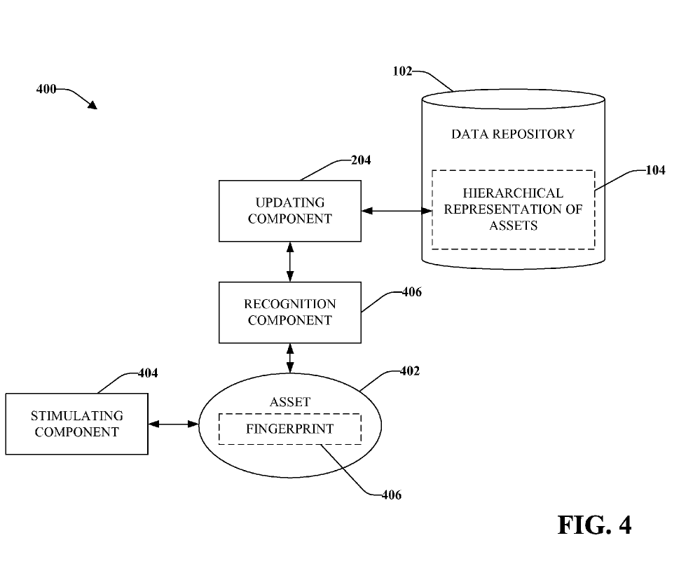

Referring now to FIG. 4, a system 400 that facilitates updating contents of the hierarchical representation of assets 104 is illustrated. The system 400 includes the data repository 102, which includes the hierarchical representation of assets 104. The data repository 102 can be a computer-readable medium, such as a hard disk, memory, and/or a combination thereof. The system 400 depicts an instance that an asset 402 does not include sufficient intelligence to inform the updating component 204 of its identity when such asset 402 is coupled to a network. It may be known, however, how particular assets react to certain stimulation. Accordingly, when the asset 402 is added to a network, a stimulating component 404 can provide the asset with certain electrical stimuli. The asset 402 is associated with a fingerprint 406 that can be utilized to identify the asset 402, wherein the fingerprint 406 makes itself known when provided with particular stimuli. Pursuant to one example, the stimulating component 404 can be an electrical power source which provides certain electrical pulses to the asset 402 to determine the fingerprint 406. For instance, the asset 402 can react in a certain manner to particular stimuli, thus illuminating the fingerprint 406 to a recognition component 408. The recognition component 408 can be trained to monitor responses of the asset 402 with respect to certain stimuli provided by the stimulating component 404.

Thus, the recognition component 408 can determine an identity of the asset (and possibly relationships to other assets) by discerning the fingerprint 406 associated with such asset 402. The updating component 204 can thereafter utilize this information as well as other available information to update the hierarchical representation of assets 104. Thus, a representation of the asset 402 can be placed appropriately within the hierarchical representation of assets 104 by the updating component 204. Asset management functionality associated with the asset can also be discerned based at least in part upon the fingerprint 406 (e.g., whether device backup is available, data archiving is available, . . .).

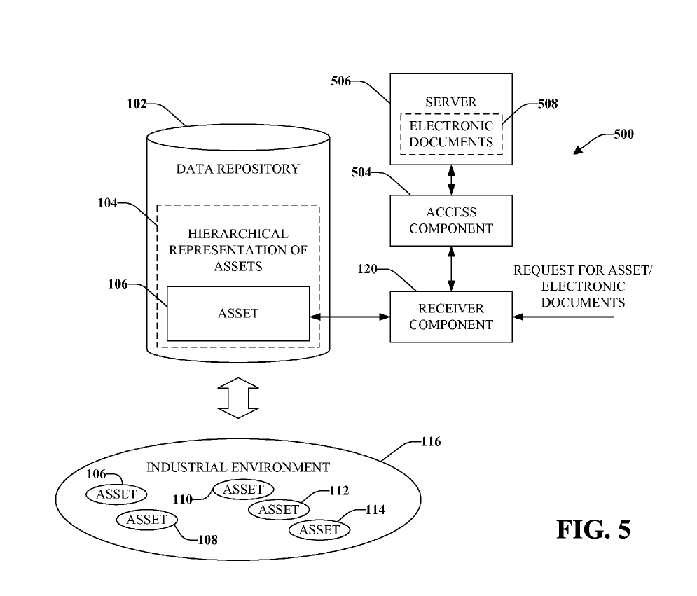

Turning now to FIG. 5, an asset management system 500 is illustrated. The system 500 includes the data repository 102 that retains the hierarchical representation of assets 104, which represent the logical and/or geographic arrangement of the plurality of assets 106-114 within the industrial environment 116. The system 500 additionally includes the receiver component 120, which receives a request for an asset and electronic documents associated with such asset. For instance, a user can utilize a mouse to select a representation 502 of the aforementioned asset within a graphical display of the hierarchical representation of assets 104. Once selected, options relating to reviewing or updating one or more electronic documents can be provided to the user. Furthermore, the user can be made aware of types of electronic documents available with respect to a desired asset (e.g., warranty documents, schematics, user manuals, etc.). The user can select a desired electronic document through use of the receiver component 120.

Once an electronic document or documents is selected, an access component 504 can be initiated, which accesses a server 506 that retains a plurality of electronic documents 508. The access component 504 can retrieve an appropriate electronic document and provide such document to, for instance, a client device that is being employed by the user. It may be desirable, however, to prohibit transmittal of one or more of the electronic documents 508—therefore, a virtual private network (VPN) can be utilized to enable review of electronic documents on the server 506 but prevent replication and/or transmittal of such documents. Additionally or alternatively, time limitations can be associated with certain electronic documents, such that a user can review a certain document for a limited amount of time prior restricting access to such document.

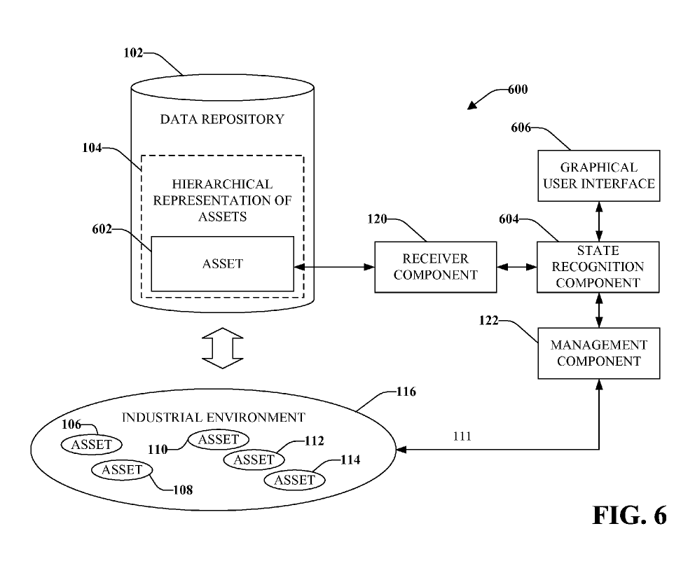

Now referring to FIG. 6, an asset management system 600 for utilization in connection with an industrial environment is illustrated. The system 600 includes the receiver component 120 that receives a request with respect to a representation of an asset 602 within the industrial environment 116. For example, a user may wish to perform a backup with respect to a particular asset within the industrial environment 116. Prior to enabling such functionality, however, a state recognition component 604 can be employed to discern states of assets within the industrial environment 116. For example, certain functionality may not be available given certain states of assets.

The system 600 can additionally include a graphical user interface 606 that displays the hierarchical representation of assets 104 as well as functionality available therewith (upon selection of a representation of at least one asset). Therefore, the graphical user interface 606 can display state-dependent functionality to a user.

According to one example, verifying a particular procedure may not be available while devices utilized within the procedure are associated with certain states. Therefore, the graphical user interface 606 will not display such functionality as being available. Once the user selects a particular functionality, the management component 122 can perform the selected asset management functionality on selected assets within the industrial environment 116. The management component 122 may communicate with the assets via a network 111.

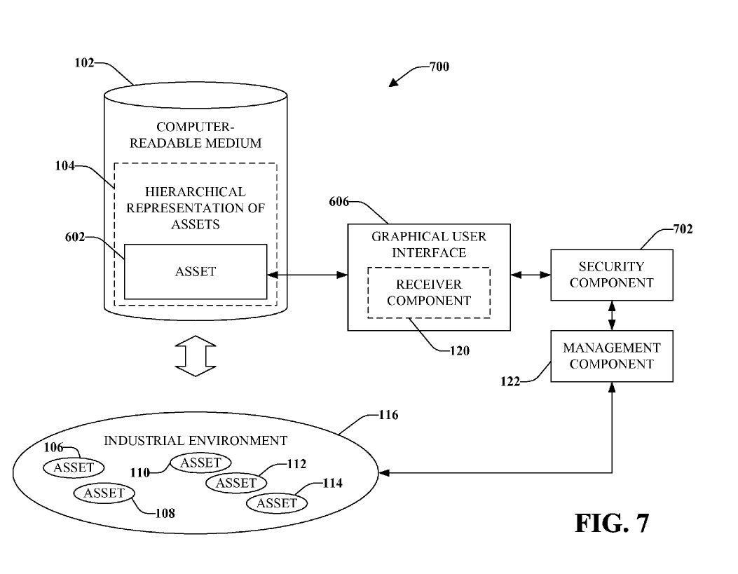

Turning now to FIG. 7, an asset management system 700 is illustrated. The system 700 includes the receiver component 120 that receives a request for an asset (or representation thereof) from a user. In one example, the receiver component 120 can be within and/or associated with the graphical user interface 606. For instance, a user can submit a request to manage an asset through use of a mouse and graphical icons displayed upon the graphical user interface 606. The system 700 additionally includes a security component 702 that can determine which assets and/or functionalities associated therewith the user is authorized to request/implement. In accordance with one example, a user may only be authorized to implement certain management functionalities with respect to a certain asset, while not authorized to implement other particular management functionalities associated with such asset. The security component 702 can determine identity of a user by analyzing, for instance, usernames, passwords, personal identification numbers, and the like. Furthermore, the security component 702 can determine a user's identity by analyzing biometric indicia, such as voice recognition, fingerprint analysis, retina analysis, etc.

Still further, the security component 702 can perform granular security with respect to a user and/or an asset. Pursuant to one example, a user's rights with respect to a particular asset can change as time alters. For instance, certain management functionality associated with an asset requested by a user can be accessible by the user during a first shift but not accessible to the user during a second shift. Additionally, the security component 702 can provide different measures of security given different states of an asset. Therefore, for example, a user may have rights with respect to functionality when an asset is in a first state but may have different rights with respect to the same functionality when the asset is in a second state. Once a user has been identified and rights associated with such user have been determined, the user can select functionality associated with an asset within the industrial environment 116. The management component 122 can thereafter be employed to implement such functionality with respect to an appropriate asset (or assets). As described above, management functionality undertaken with respect to one asset can be permeated through subordinate assets in a hierarchy.

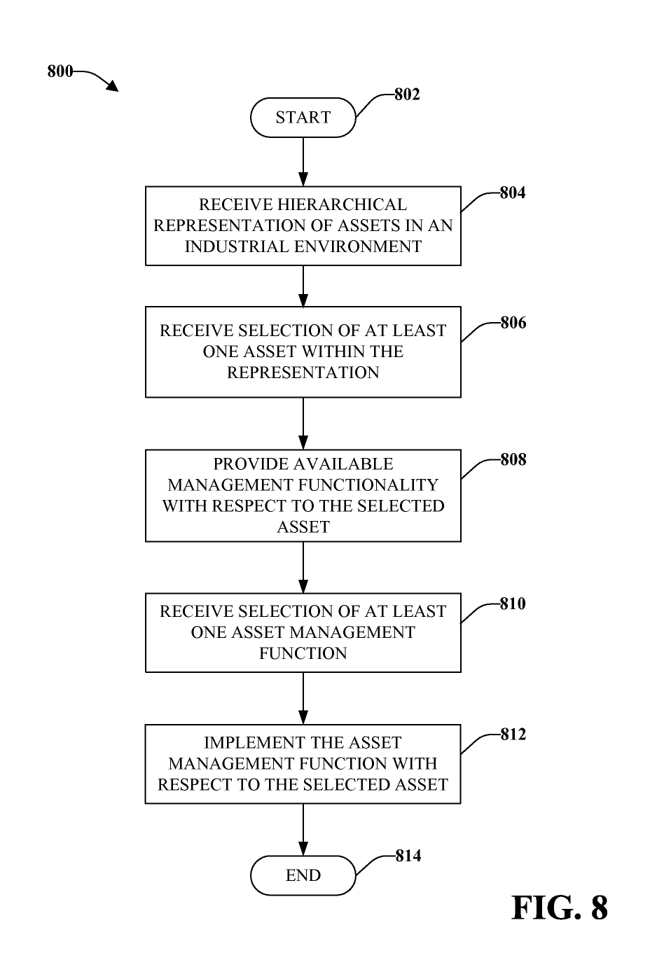

Referring to FIGS. 8-10, methodologies in accordance with various aspects of the claimed subject matter are illustrated. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning specifically to FIG. 8, a methodology 800 for managing one or more assets within an industrial environment. The methodology 800 starts at reference numeral 802, and at reference numeral 804 a hierarchical representation of assets in an industrial environment can be received. It is to be appreciated that an asset can be, but is not limited to, a physical device, such as a programmable logic controller, a pump, a press, and/or a portion thereof, as well as software, firmware, etc. Moreover, the hierarchical representation of assets can be, for instance, provided by a user and/or an electronic document/data. In one example, a user can evaluate an industrial environment and create the hierarchical representation by at least one of uploading data, creating an electronic document, employing a graphical user interface (GUI), and the like.

The hierarchy can be based upon location of devices (e.g., a region of a factory can have several defined sub-regions, which in tum can comprise sub-regions), standards associated with industry, such as ISA S95, ISA S88, and the like, a proprietary hierarchy that is provided by an enterprise, or any other suitable hierarchy. For example, a top portion of the hierarchy may be a plant, and a sub-level of the plant may be programmable logic controllers utilized within the plant, and a sub-level of the programmable logic controllers can be devices controlled by such controllers. It is understood and appreciated that this is but one example of a hierarchy, and the claimed subject matter is not to be so limited. Furthermore, the hierarchically representation of assets can represent a hierarchically arrangement of two or more assets within an industrial environment, such as one that is utilized to manufacture consumables, textiles, automobiles, or any other suitable industrial environment. To illustrate another example hierarchy, the asset may be a programmable logic controller, while the assets and may be different control programs effectuated by the asset. Thus, the hierarchical representation of assets may be a combination of physical devices and software.

At reference numeral 806, a selection of at least one asset within the representation can be received. For instance, the selection of the asset can be via an interface, a graphical user interface (GUI), an input device, an application programmable interface (API), a pointing and clicking mechanism, a pressure-sensitive screen, voice commands, software associated with selecting the representation of the asset, or any other suitable manner for selecting an asset. At reference numeral 808, available management functionality is provided with respect to the selected asset. For example, the user can select an asset and the respective functionality and/or functionalities can be effectuated for the particular asset within the industrial environment. At reference numeral 810, a selection of at least one asset management function can be received. For instance, the selection of the asset management function can be via an interface, a graphical user interface (GUI), an input device, an application programmable interface (API), a pointing and clicking mechanism, a pressure-sensitive screen, voice commands, software associated with selecting the representation of the asset, or any other suitable manner for selecting an asset management function. At reference numeral 812, the asset management function can be implemented with respect to the selected asset. Thus, for instance, if the representation of the asset represents a PLC, and the user selects such representation, functionality such as “back up PLC”, “archive data within the PLC”, “update PLC with particular firmware”, and the like can be provided to the user. Once the user selects desired functionality, the requested function can be automatically performed. For instance, the PLC can be backed up if the user selects the “backup PLC” functionality. The methodology 800 then completes at reference numeral 814.

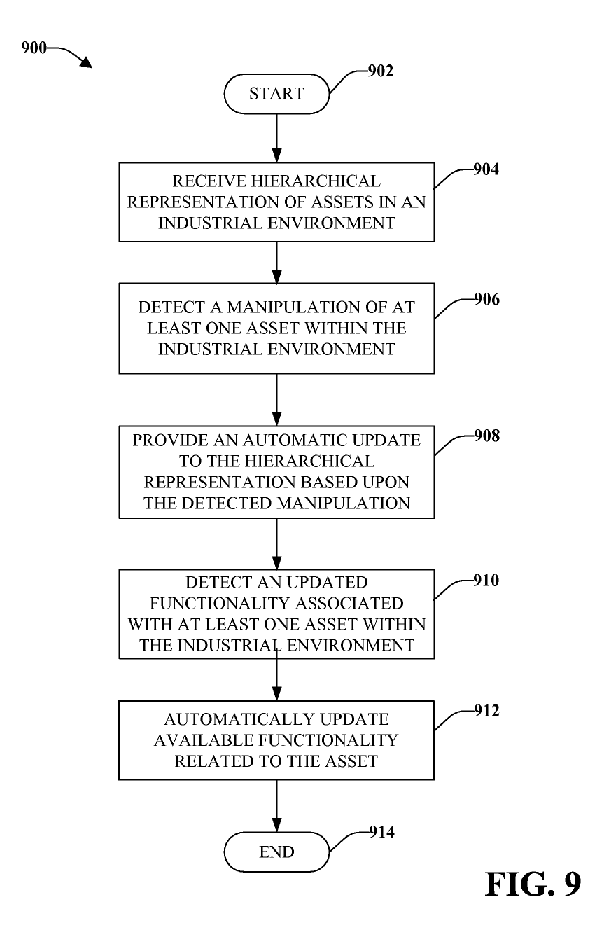

Turning now to FIG. 9, a methodology 900 for automatically updating the hierarchical representation of assets with respect to assets that are added, updated, or removed from the industrial environment. The methodology 900 starts at reference numeral 902, and at reference numeral 904 a hierarchical representation of assets in an industrial environment can be received. It is to be appreciated that the hierarchical representation can be based upon location, and various devices and software can reside in the hierarchy beneath the location. One skilled in the art will appreciate that various asset management functionalities can be permeated throughout any suitable portions of a hierarchy and/or a hierarchical representation of assets within an industrial environment. Moreover, an asset can be, for example, a physical device, such as a programmable logic controller, a pump, a press, and/or a portion thereof, as well as software, firmware, etc. At reference numeral 906, a manipulation of at least one asset within the industrial environment can be detected. For example, assets within the industrial environment can be edited, reconfigured, relocated, added, removed, updated, and the like. Thus, once an asset has been manipulated in such a manner, such manipulation and/or change can be detected accordingly. At reference numeral 908, an automatic update to the hierarchical representation can be provided based at least in part upon the detected manipulation. In other words, the hierarchical representation of assets can be continuously updated and/or maintained in connection with the various changes that may affect an asset within the industrial environment.

At reference numeral 910, an updated functionality associated with at least one asset within the industrial environment can be detected. For example, an asset within the industrial environment can be updated to provide additional functionality, updated functionality, disparate operations, and the like. At reference numeral 912, the available functionality for an asset can be automatically updated to allow for implementation. In other words, an asset functionality can be added, automatically detected and updated to allow a user to employ such functionality on the particular asset. The methodology 900 then completes at reference numeral 914.

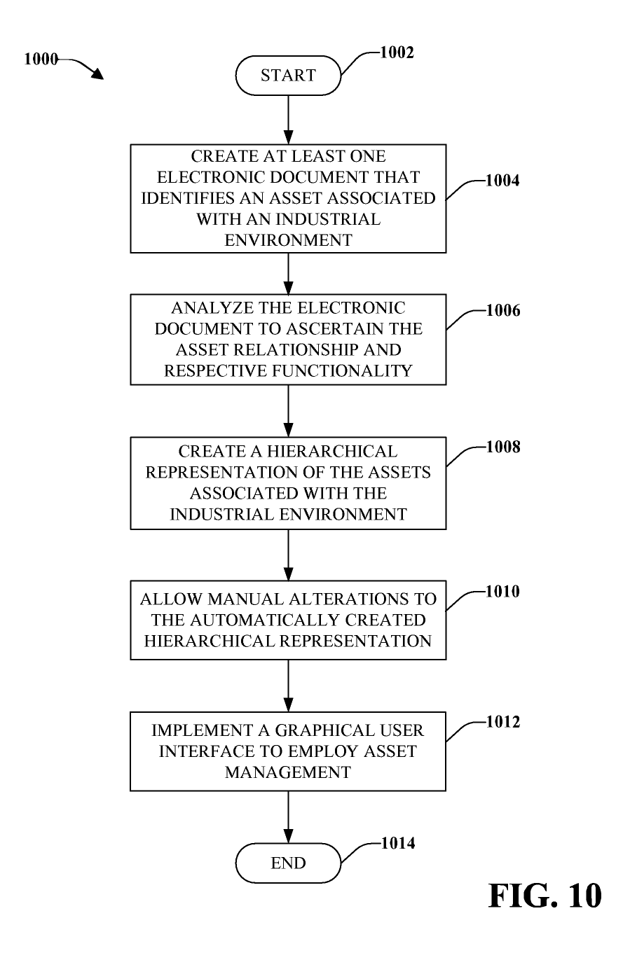

Referring now to FIG. 10, a methodology 1000 that facilitates automatically creating a hierarchical representation of assets. The methodology 1000 starts at reference numeral 1002, and at reference numeral 1004 at least one electronic document that identifies an asset associated with an industrial environment can be created. For instance, the electronic document can be associated with an asset that is employed and/or is possibly employed within the industrial environment. The electronic document may be descriptive of operation of assets, such as operation instructions. The electronic document can also be a warranty or any other suitable documents relating to assets within the industrial environment. At reference numeral 1006, the electronic document can be analyzed to ascertain the asset relationship and respective functionality. In other words, the electronic document can provide any suitable information related to the particular asset such as, but not limited to, available asset management functionality and/or operations, location and/or relationship within a hierarchical representation of at least a portion of the totality of assets within an industrial environment, etc.

At reference numeral 1008, a hierarchical representation of the assets associated with the industrial environment can be built and/or created. For instance, based on a plurality of assets within a particular industrial environment, wherein at least one electronic document relates to the assets, a hierarchical representation of the assets can be created based upon data included within the electronic document(s). At reference numeral 1010, manual alterations to the automatically created hierarchical representation can be employed. For instance, upon automatic creation of the hierarchical representation of assets, a user may desire to implement manual alterations and/or changes accordingly. At reference numeral 1012, a graphical user interface (GUI) can be implemented to facilitate employing asset management in connection with the industrial environment. In one example, the graphical user interface can display the hierarchical representation of assets as well as functionality available therewith (upon selection of a representation of at least one asset). Therefore, the graphical user interface can display state-dependent functionality to a user. The methodology 1000 then completes at reference numeral 1014.

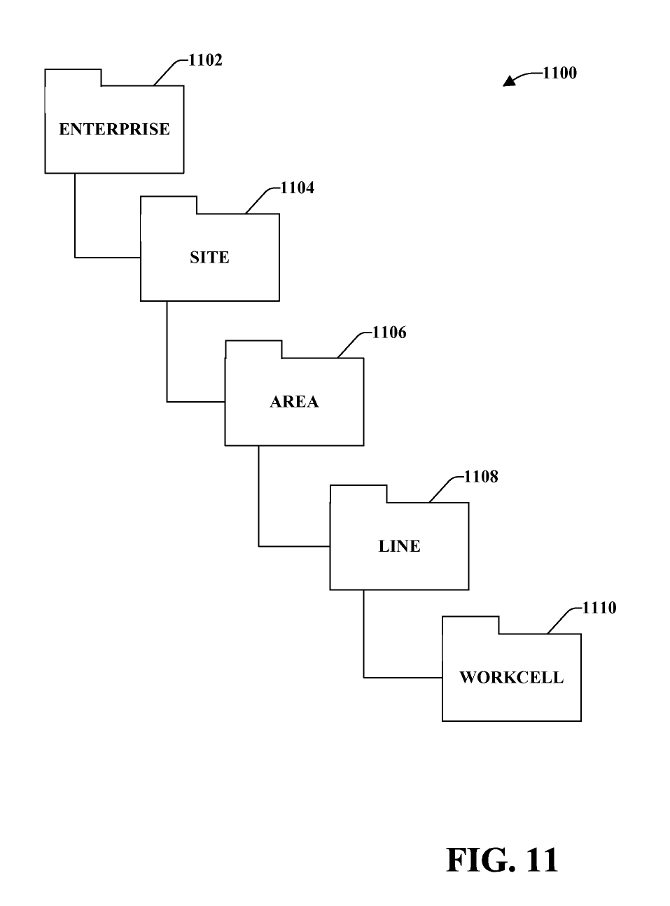

Referring now to FIG. 11, an exemplary hierarchical structure 1100 which can be utilized in connection with the hierarchically structured data model (e.g., hierarchical representation of assets) alluded to herein is illustrated. For example, the data model can facilitate nested structures, thereby mitigating deficiencies associated with data models that employ flat namespaces. The structure 1100 includes an enterprise level 1102, where a particular enterprise can be represented within data structured in accordance with a hierarchical data model. Beneath the enterprise level 1102 can be a site level 1104, so that a particular factory (site) within an enterprise can be represented within a data packet. Beneath the site level 1104 an area level 1106 can exist, which specifies an area within the factory that relates to the data. A line level 1108 can lie beneath the area level 1106, wherein the line level 1108 is indicative of a line associated with particular data. Beneath the line level 1108 a workcell level 1110 can exist, thereby indicating a workcell associated with the data. Utilizing a nested, hierarchical data model, PLCs can become more aware of data associated therewith. Furthermore, the hierarchy 1100 can be customized by an owner of such hierarchy. For instance, more granular objects/levels can be defined within the hierarchy 1100 in relation to the various assets associated therewith.

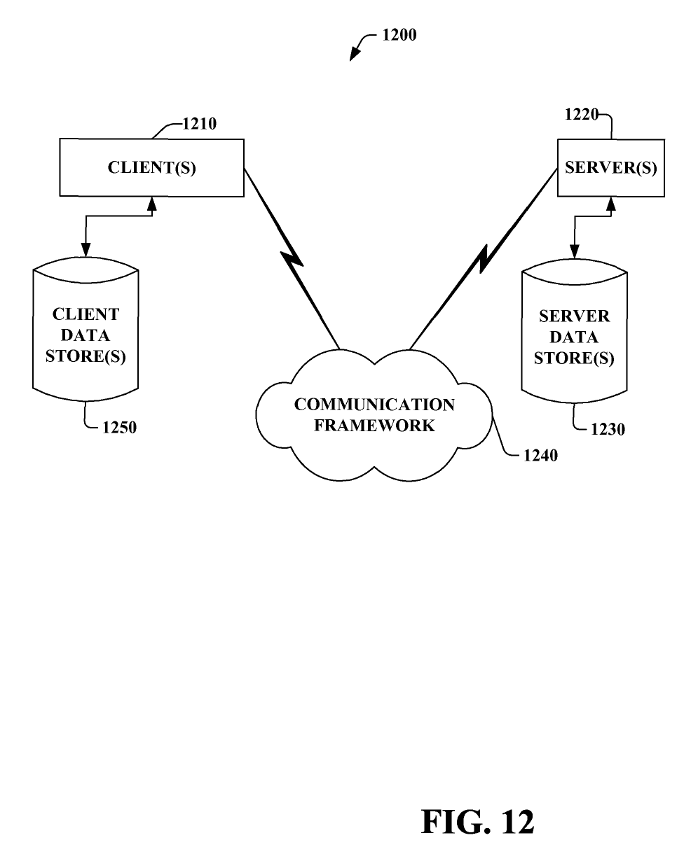

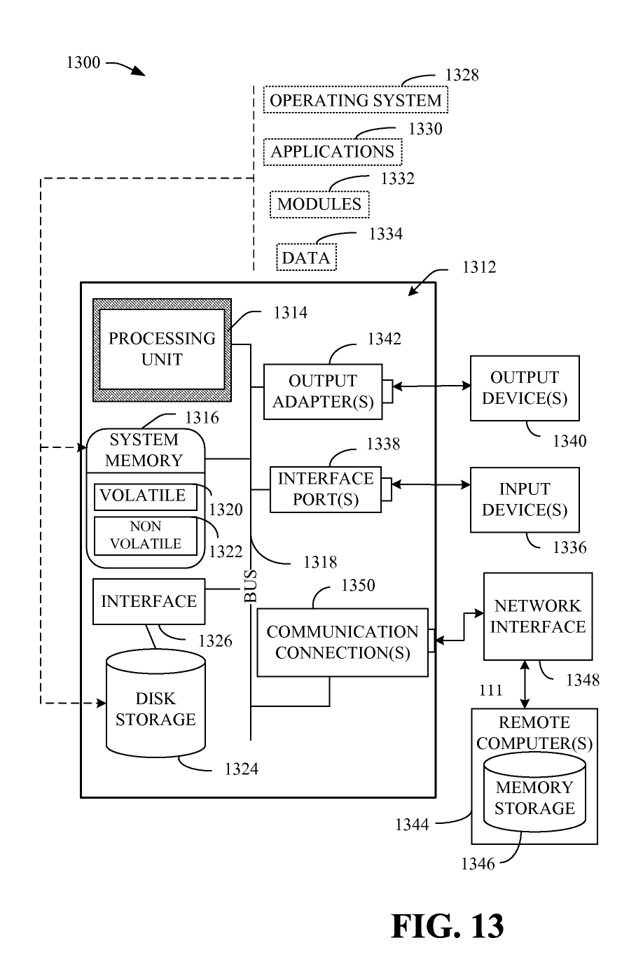

In order to provide additional context for implementing various aspects of the claimed subject matter, FIGS. 12-13 and the following discussion is intended to provide a brief, general description of a suitable computing environment in which the various aspects of the subject innovation may be implemented. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single- processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a network 111. However, some, if not all, aspects of the subject innovation may be practiced on stand-alone computers. In a distributed computing environment, program modules may be located in local and/or remote memory storage devices. FIG. 12 is a schematic block diagram of a sample-computing environment 1200 with which the claimed subject matter can interact. The system 1200 includes one or more client(s) 1210. The client(s) 1210 can be hardware and/or software (e.g., threads, processes, computing devices). The system 1200 also includes one or more server(s) 1220. The server(s) 1220 can be hardware and/or software (e.g., threads, processes, computing devices). The servers 1220 can house threads to perform transformations by employing the subject innovation, for example.

One possible communication between a client 1210 and a server 1220 can be in the form of a data packet adapted to be transmitted between two or more computer processes. The system 1200 includes a communication framework 1240 that can be employed to facilitate communications between the client(s) 1210 and the server(s) 1220. The client(s) 1210 are operably connected to one or more client data store(s) 1250 that can be employed to store information local to the client(s) 1210. Similarly, the server(s) 1220 are operably connected to one or more server data store(s) 1230 that can be employed to store information local to the servers 1220.

With reference to FIG. 13, an exemplary environment 1300 for implementing various aspects of the claimed subject matter includes a computer 1312. The computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable programmable ROM (EEPROM), or flash memory. Volatile memory 1320 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1312 also includes removable/non-removable, volatile/non-volatile computer storage media. FIG. 13 illustrates, for example a disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used such as interface 1326.

It is to be appreciated that FIG. 13 describes software that acts as an intermediary between users and the basic computer resources described in the suitable operating environment 1300. Such software includes an operating system 1328.

Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. It is to be appreciated that the claimed subject matter can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312, and to output information from computer 1312 to an output device 1340. Output adapter 1342 is provided to illustrate that there are some output devices 1340 like monitors, speakers, and printers, among other output devices 1340, which require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network 111 and a network interface 1348 and then physically connected via communication connection 1350. Network interface 1348 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like.

WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, ISDN adapters, and Ethernet cards.

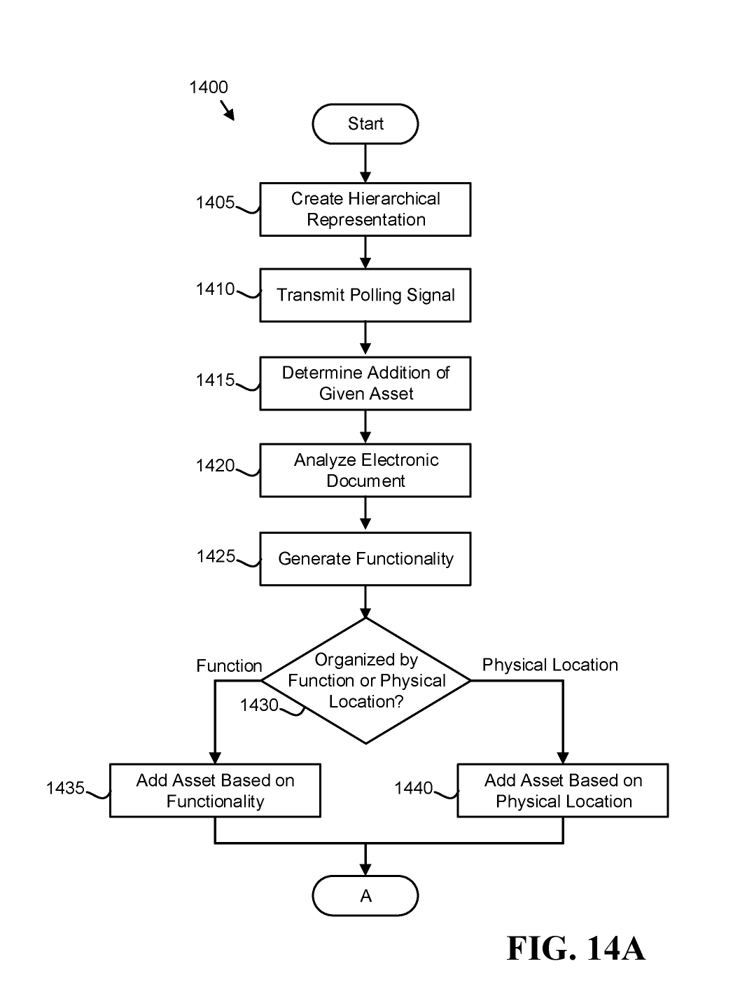

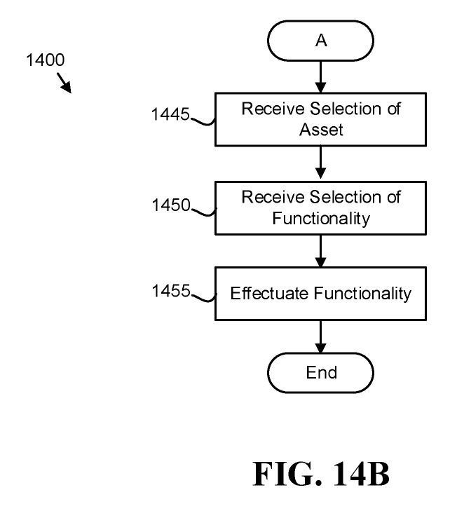

Referring now to FIGS. 14A-B, an exemplary method 1400 for creating a hierarchical representation 104 and effectuating functionality is illustrated. The method 1400 creates the hierarchical representation 104, determines an addition of a given asset 106, generates a functionality of the given asset 106, adds the given asset 106 to the hierarchical representation 104, and effectuates the functionality of the given asset 106. The method 1400 may be performed by one or more processors.

The method 1400 starts at reference 1402 and the one or more processors may create 1405 the hierarchical representation 104 in the data repository 102 of a plurality of assets 106-114 communicating on at least one network 111 and employed to perform manufacturing within an industrial environment 116. The hierarchical representation 104 may be created as described in reference 1402 of FIG. 10. In a certain embodiment, the hierarchical representation 104 is created without assets 106 and assets 106 are subsequently added as described hereafter at reference 1420.

At reference 1410, the one or more processors may transmit a polling signal on the at least one network 111. The transmission of the polling signal is described in more detail in FIG. 2.

At reference 1415, the one or more processors determine an addition of a given asset 106 to the industrial environment 116 based upon at least one response to the polling signal. The addition of the given asset 106 may be determined if the given asset 106 responds to the polling signal and the given asset 106 is not in the hierarchical representation 104. The given asset 106 may be a physical device. At reference 1420, the one or more processors may analyze an electronic document 302 that corresponds to the given asset 106. The electronic document 302 may be retrieved using an asset identifier received in response to the polling signal. In one embodiment, the processors analyze the electronic document 302 by parsing text and/or illustrations from the electronic document 302 and identifying functional language and/or functional illustrations within the electronic document 302.

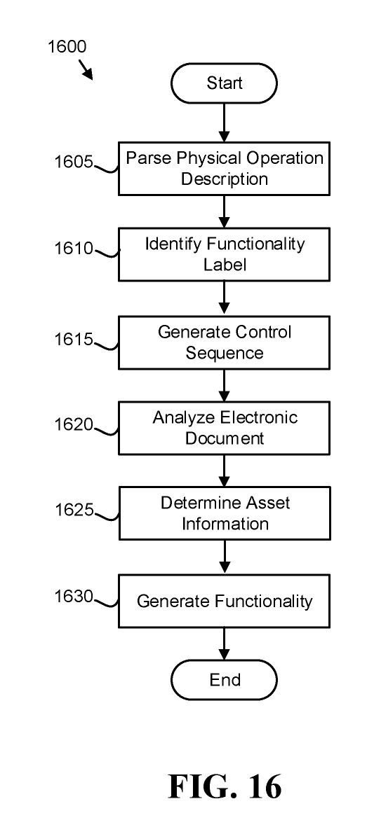

At reference 1425, the one or more processors generate a functionality for the given asset 106. The processors may generate the functionality data 1500 that describes the functionality for the given asset 106. The generation of the functionality for the given asset 106 is described in more detail in FIG. 16.

At reference 1430, the one or more processors determine whether the hierarchical representation 104 is organized according respective functionalities of the plurality of assets 106-114 or respective physical locations of the plurality of assets 106-114 in the industrial environment 116. In one embodiment, the one or more processors determine that the hierarchical representation 104 for is organized according to functionalities if the assets 106-114 are grouped by functionality labels. In addition, the one or more processors may determine that the hierarchical representation 104 is organized according to physical locations of the plurality of assets 106-114 if the assets 106-114 are grouped by asset locations.

At reference 1435, in response to a determination that the hierarchical representation 104 is organized according respective functionalities of the plurality of assets 106-114, the one or more processors may add the given asset 106 to the hierarchical representation 104 based upon the functionality of the given asset 106. At reference 1440, in response to a determination that the hierarchical representation 104 is organized according respective physical locations of the plurality of assets 106-114, the one or more processors may add the given asset 106 to the hierarchical representation 104 based upon a physical asset location of the given asset 106.

At reference 1445, the one or more processors receive a selection of the given asset 106. The selection may be received from a GUI that displays a portion or all of the hierarchical representation 104. In one embodiment, the given asset 106 and functionality data 1500 for the given asset 106 is presented in response to the selection of the given asset 106.

At reference 1450, the one or more processors receive a selection of the functionality for the given asset 106. The selection may be received from the GUI. At reference 1455, the one or more processors may effectuate the functionality of the given asset 106 in response to the selection of the given asset 106 and the functionality of the given asset 106.

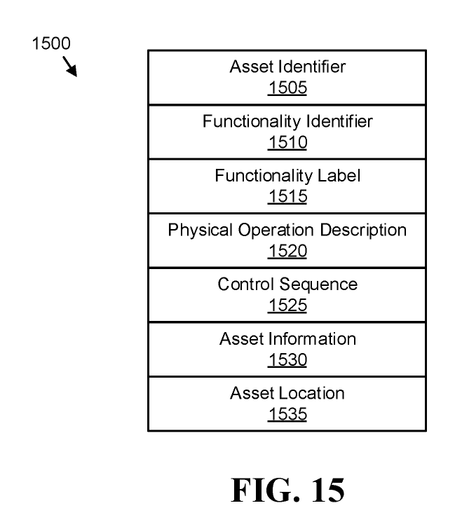

Referring now to FIG. 15, a schematic block diagram of functionality data 1500 that describes a functionality of an asset 106 is illustrated. The functionality data 1500 maybe organized as a data structure in the system memory 1316 and/or the disk storage 1324. In the depicted embodiment, the functionality data 1500 includes an asset identifier 1505, a functionality identifier 1510, a functionality label 1515, a physical operation description 1520, a control sequence 1525, asset information 1530, and an asset location 1535.

The asset identifier 1505 identifies the asset 106 associated with the functionality and the functionality data 1500. The asset identifier 1505 may reference the asset 106 in the hierarchical representation 104. The functionality identifier 1510 may uniquely identify the functionality and the functionality data 1500. The functionality label 1515 may identify the functionality to an operator.

The physical operation description 1520 may describe the physical operation of the asset 106. The physical operation description 1520 may be parsed from an electronic document 302. In one embodiment, delimiters are inserted in the physical operation description 1520 to identify actions and/or controls. For example, actions such as “open,” or “power on” may be identified with the delimiters. A delimiter may be one or more specified text characters.

The control sequence 1525 identifies one or more commands that are communicated to the asset 106 in a specified sequence to effectuate the functionality. The commands may be parsed from the electronic document 302 and/or the physical operation description 1520 associated with the asset 106.

The asset information 1530 may record additional information regarding the asset 106. In one embodiment, the asset information 1530 includes one or more of a warranty for the asset 106, a time of purchase of the asset 106, and/or an identity of an individual who purchased the asset 106. The asset location 1535 may specify where the asset 106 is physically located in the industrial environment 116.

Referring now to FIG. 16, an exemplary method 1600 for generating functionality is illustrated. The method 1600 may generate the functionality and the functionality data 1500 for a given asset 106. In one embodiment, the method 1600 perform reference 1425 of FIG. 14A. The method 1600 may be performed by one or more processors.

The method 1600 starts, and at reference 1605, the one or more processors parse the physical operation description 1520 from the electronic document 302 associated with the asset 106. In one embodiment, the one or more processors employ word clustering to identify one or more features of the asset 106 from the electronic document 302. For example, a phrase such as “emergency stop” may be the basis of a word cluster describing a feature of the asset 106. Sentences and/or paragraphs that include the phrase “emergency stop” may be associated in a word cluster. The one or more processors may further identify the features from each word cluster, with each word cluster identifying a candidate feature.

In one embodiment, the features are identified using a neural network that is trained with a plurality of electronic documents 302. The neural network may be trained using one of supervised learning and unsupervised learning. In the supervised learning embodiment, the neural network may be trained with training data that comprises text and/or illustrations that describe a feature and a feature label. The trained neural network may identify each feature from the physical operation description 1520 and/or word clusters. In the unsupervised learning embodiment, the neural network may receive the physical operation description 1520 parsed from the electronic documents 302 without prior training and identify the features.

The one or more processors may further compare the identified features of the given asset 106 against keywords describing operations, functionality, and commands for a plurality of assets in a plurality of asset classes. The operations, functionality, and commands for the given asset 106 may be identified using the keywords. For example, the keyword “open” may be used to identify the operations, functionality, and commands related to opening a valve of the asset 106.

At reference 1610, the one or more processors identify the functionality label 1515 from the feature and/or physical operation description 1520. The functionality label 1515 may be set equal to one or more nouns most commonly used to describe a feature.

At reference 1615, the one or more processors generate the control sequence 1525 of commands from the physical operation description 1520. For example, a sequence of text commands from the physical operation description 1520 may be identified based on the keywords. In addition, delimiters may be added to each command. The delimited commands may be organized in a sequence. Each command may be associated with a control message from the electronic document 302 that may be communicated to the asset 106 to effectuate the functionality. For example, a binary “open” command may be associated with the text command “open.” The sequence of control messages in the control sequence 1525 may be communicated to the asset 106 to effectuate the functionality.

At reference 1620, the one or more processors may analyze the electronic document 302 for the asset information 1530 not related to the physical operation description 1520. By analyzing the electronic document 302 for asset information 1530 that is not related to the physical operation description 1520, extraneous word clusters are not created that may result in false functionality being generated. In one embodiment, the processors analyze the electronic document 302 for text related to the asset information keywords “warranty” and “purchase.” At reference 1625, the one or more processors may determine the asset information 1530. In one embodiment, the asset information 1530 comprises at least one of a warranty of the asset 106, a time of purchase of the asset 106, and an identity of an individual who purchased the asset 106.

At reference 1630, the one or more processors generate the functionality by recording the asset identifier 1505 for the asset 106, the functionality label 1515, the physical operation description 1520, and the control sequence 1525 to the functionality data 1500 and the method 1600 ends. The one or more processors may further generate the functionality identifier 1510 as a unique string. The functionality label 1515 may be used to identify the functionality when presented via the GUI. In one embodiment, when the functionality label 1515 is selected, the one or more processors may effectuate the functionality by executing the control sequence 1525. The one or more processors may also record the asset information 1530 to the functionality data 1500.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system comprising:
one or more processors;
one or more memory communicatively coupled to the one or more processors, the one or more memory having stored therein computer-executable instructions executable by the one or more processors to:
create a hierarchical representation in a data repository of a plurality of assets communicating on at least one network and employed to perform manufacturing within an industrial environment;
transmit a polling signal on the at least one network;
determine an addition of a given asset to the industrial environment based upon at least one response to the polling signal, wherein the given asset is a physical device;
analyze an electronic document that corresponds to the given asset, wherein the electronic document is a human language document;
generate a functionality of the given asset from the electronic document by parsing a description of a physical operation of the given asset from the electronic document, parsing a functionality label for the physical action from the description of the physical operation, and parsing a control sequence from the electronic document, wherein the functionality is identified by the functionality label and effectuating the functionality activates the control sequence;
determine whether the hierarchical representation is organized according respective functionalities of the plurality of assets or respective physical locations of the plurality of assets in the industrial environment;
in response to a determination that the hierarchical representation is organized according respective functionalities of the plurality of assets, add the given asset to the hierarchical representation based upon the functionality of the given asset;
in response to a determination that the hierarchical representation is organized according respective physical locations of the plurality of assets, add the given asset to the hierarchical representation based upon a physical location of the given asset; and
effectuate the functionality of the given asset in response to a selection of the given asset and the functionality of the given asset.

2. The system of claim 1, wherein the one or more processors further:
detect a change in the physical location of the given asset within the industrial environment to a new physical location; and
in response to the change in the physical location of the given asset within the industrial environment to the new physical location and the determination that the hierarchical representation is organized according respective physical locations of the plurality of assets, move the given asset in the hierarchical representation based upon the new physical location of the given asset.

3. The system of claim 1, wherein the one or more processors further analyze the electronic document to determine at least one of a warranty of the given asset, a time of purchase of the given asset, and an identity of an individual who purchased the given asset.

4. The system of claim 1, wherein the one or more processors further detect one of that the given asset has been removed from the industrial environment and that the given asset has been updated with additional functionality within the industrial environment.

5. The system of claim 4, wherein the one or more processors further automatically update the hierarchical representation in response to detecting at least one of the given asset being removed from the industrial environment and the given asset being updated with additional functionality.

6. The system of claim 1, wherein the one or more processors receive a message from the given asset that the given asset is one or more of being added to the industrial environment, being removed from the industrial environment, and being updated with additional functionality, wherein the message comprises at least one of a type of the given asset, an identity of the given asset, a location upon a network of the given asset, and a type of update to the given asset.

7. The system of claim 1, further comprising a stimulating component that provides an electrical pulse to the given asset to ascertain identification data related to the given asset and a recognition component that identifies the given asset based on a fingerprint of a reaction to the electrical pulse.

8. The system of claim 7, wherein the one or more processors utilize the identification data to detect and maintain alterations of the given asset within the industrial environment.

9. A method comprising:
creating, by a device including a processor, a hierarchical representation in a data repository of a plurality of assets communicating on at least one network and employed to perform manufacturing within an industrial environment;
transmitting a polling signal on the at least one network;
determining an addition of a given asset to the industrial environment based upon at least one response to the polling signal, wherein the given asset is a physical device;
analyzing an electronic document that corresponds to the given asset, wherein the electronic document is a human language document;
generating a functionality of the given asset from the electronic document by parsing a description of a physical operation of the given asset from the electronic document, parsing a functionality label for the physical action from the description of the physical operation, and parsing a control sequence from the electronic document, wherein the functionality is identified by the functionality label and effectuating the functionality activates the control sequence;
determining whether the hierarchical representation is organized according respective functionalities of the plurality of assets or respective physical locations of the plurality of assets in the industrial environment;
in response to a determination that the hierarchical representation is organized according respective functionalities of the plurality of assets, adding the given asset to the hierarchical representation based upon the functionality of the given asset;
in response to a determination that the hierarchical representation is organized according respective physical locations of the plurality of assets, adding the given asset to the hierarchical representation based upon a physical location of the given asset; and
effectuating the functionality of the given asset in response to a selection of the given asset and the functionality of the given asset.

10. The method of claim 9, the method further comprising:
detecting a change in the physical location of the given asset within the industrial environment to a new physical location; and
in response to the change in the physical location of the given asset within the industrial environment to the new physical location and the determination that the hierarchical representation is organized according respective physical locations of the plurality of assets, moving the given asset in the hierarchical representation based upon the new physical location of the given asset.

11. The method of claim 9, the method further analyzing the electronic document to determine at least one of a warranty of the given asset, a time of purchase of the given asset, and an identity of an individual who purchased the given asset.

12. The method of claim 9, the method further detecting one of that the given asset has been removed from the industrial environment and that the given asset has been updated with additional functionality within the industrial environment.

13. The method of claim 12, the method further automatically updating the hierarchical representation in response to detecting at least one of the given asset being removed from the industrial environment and the given asset being updated with additional functionality.

14. The method of claim 9, the method further receiving a message from the given asset that the given asset is one or more of being added to the industrial environment, being removed from the industrial environment, and being updated with additional functionality, wherein the message comprises at least one of a type of the given asset, an identity of the given asset, a location upon a network of the given asset, and a type of update to the given asset.

15. The method of claim 9, the method further providing an electrical pulse to the given asset to ascertain identification data related to the given asset and identifying the given asset based on a fingerprint of a reaction to the electrical pulse.

16. The method of claim 9, the method further utilizing the identification data to detect and maintain alterations of the given asset within the industrial environment.

17. A non-transitory computer-readable medium having instructions stored thereon that, in response to execution, cause a system including a processor to perform operations comprising:
creating a hierarchical representation in a data repository of a plurality of assets communicating on at least one network and employed to perform manufacturing within an industrial environment;
transmitting a polling signal on the at least one network;
determining an addition of a given asset to the industrial environment based upon at least one response to the polling signal, wherein the given asset is a physical device;
analyzing an electronic document that corresponds to the given asset, wherein the electronic document is a human language document;
generating a functionality of the given asset from the electronic document by parsing a description of a physical operation of the given asset from the electronic document, parsing a functionality label for the physical action from the description of the physical operation, and parsing a control sequence from the electronic document, wherein the functionality is identified by the functionality label and effectuating the functionality activates the control sequence;
determining whether the hierarchical representation is organized according respective functionalities of the plurality of assets or respective physical locations of the plurality of assets in the industrial environment;
in response to a determination that the hierarchical representation is organized according respective functionalities of the plurality of assets, adding the given asset to the hierarchical representation based upon the functionality of the given asset;
in response to a determination that the hierarchical representation is organized according respective physical locations of the plurality of assets, adding the given asset to the hierarchical representation based upon a physical location of the given asset; and
effectuating the functionality of the given asset in response to a selection of the given asset and the functionality of the given asset.

18. The non-transitory computer-readable medium of claim 17, wherein the system further:
detects a change in the physical location of the given asset within the industrial environment to a new physical location; and
in response to the change in the physical location of the given asset within the industrial environment to the new physical location and the determination that the hierarchical representation is organized according respective physical locations of the plurality of assets, moves the given asset in the hierarchical representation based upon the new physical location of the given asset.

19. The non-transitory computer-readable medium of claim 17, wherein the system further analyzes the electronic document to determine at least one of a warranty of the given asset, a time of purchase of the given asset, and an identity of an individual who purchased the given asset.

20. The non-transitory computer-readable medium of claim 17, wherein the system further detects one of that the given asset has been removed from the industrial environment and that the given asset has been updated with additional functionality within the industrial environment.
